(19) United States
(12) Patent Application Publication
(10) Pub. No.: US 2026/0195442 A1
(43) Pub. Date: Jul. 9, 2026

(54) AUTHENTICATING A USER WITH A PREMISES SECURITY SYSTEM

(71) Applicant: The ADT Security Corporation, Boca Raton, FL (US)

(72) Inventor: James KNOX, Media, PA (US)

(21) Appl. No.: 19/009,202

(22) Filed: Jan. 3, 2025

(51) Int. Cl. G06F 21/46; G06F 21/32; H04L 9/32

(52) U.S. Cl. CPC G06F 21/46; G06F 21/32; H04L 9/3226; G06F 21/30; G06F 21/305; G06F 21/31; G06F 21/34; G06F 21/35; G06F 21/62; H04W 12/06

(57) ABSTRACT

Embodiments herein describe using a premises security system (e.g., a home or business security system) to support an authentication factor for a user, such as when they log into an application, web portal, or the like. For example, the user may submit their username and password for the application, web portal, etc. to an authentication system, which then prompts the user to perform an act with their premises security system that itself requires authentication. In one embodiment, the authentication system may prompt the user perform an action such as arming or disarming the premises security system. In one embodiment, the authentication system may itself provide a particular code, pass-phrase to speak, etc. to the user to use to demonstrate their proximity or access to the premises security system. Once the security system confirms the user performed the desired action, the authentication system completes the login process.

### TECHNICAL FIELD

Embodiments presented in this disclosure generally relate to secure login and more specifically, to using a security system at a premises to authenticate a user.

### BACKGROUND

Logging into an application, web portal, or other interface often requires authenticating the identity of a user through a username and password and/or other knowledge-based authenticators (KBAs). However, simply providing a username and password might not been seen as sufficiently secure given data breaches, poor password management, password crackers, and the like. As such, many authentication systems require multi-factor authentication (MFA) which requires another verification step such as receiving a text message or an email with a code or providing a code from an authenticator application. However, there are situations where a user may not currently have access to their email or phone, or may struggle with the MFA process. The embodiments described herein illustrate techniques for authenticating a user with a premises security system.

### BRIEF DESCRIPTION OF THE DRAWINGS

So that the manner in which the above-recited features of the present disclosure can be understood in detail, a more particular description of the disclosure, briefly summarized above, may be had by reference to embodiments described herein, some of which are illustrated in the appended drawings. It is to be noted, however, that the appended drawings and descriptions herein illustrate embodiments and are therefore not to be considered limiting; other embodiments are contemplated.

FIG. 1 illustrates a premises security system, according to one embodiment.

FIG. 2 is a flowchart for establishing identification information for arming and disarming a premises security system, according to one embodiment.

FIG. 3 is a flowchart for using a technique for arming or disarming a premises security system to provide a secure login, according to one embodiment.

FIG. 4 is a flowchart for using a controller for a premises security system to provide a secure login, according to one embodiment.

FIG. 5 is a flowchart for using a premises security system or MFA to provide a secure login, according to one embodiment.

FIG. 6 is a flowchart for using an application to control and access a premises security system, according to one embodiment.

FIG. 7 is a workflow for logging a user into an application using a premises security system controller, according to one embodiment.

FIGS. 8-10 illustrate different implementations of the workflow in FIG. 7.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF DISCLOSED EMBODIMENTS

### Overview

One embodiment presented in this disclosure is a method that includes receiving a username provided by a user that is part of a login request, identifying a premises security system corresponding to the username provided by the user where the premises security system includes at least one physical device configured for the detection of an intrusion at a premises by an unauthorized person and is configured for an action that requires authentication using the premises security system, determining, using the physical device, that the action was performed on the security system, and responsive to determining that the action was performed, transmitting a confirmation to an authentication system so the login request can be approved.

Another embodiment presented in this disclosure is an apparatus that includes an input/output (I/O) device for disarming or controlling a premises security system, wherein the I/O device is further configured to detect a user action that is performed as part of a request to log into an application or a web portal, and a radio configured to transmit, upon detecting the user action, a confirmation of an identity of a user so the login request can be approved.

Another embodiment presented in this disclosure is a non-transitory computer readable medium containing computer program code that, when executed by operation of one or more computer processors, performs an operation. The operation includes receiving a username provided by a user that is part of a login request, identifying a premises security system corresponding to the username provided by the user where the premises security system includes at least one physical device configured for the detection of an intrusion at a premises by an unauthorized person and is configured for an action that requires authentication using the premises security system, determining, using the physical device, that the action was performed on the security system, and responsive to determining that the action was performed, transmitting a confirmation to an authentication system so the login request can be approved.

### EXAMPLE EMBODIMENTS

Embodiments herein describe using a premises security system (e.g., a home or business security system) to support an authentication factor for a user, such as when they log into an application, web portal, or the like. For example, the user may submit their username and password for the application, web portal, etc. to an authentication system, which then prompts the user to perform an act with their premises security system that itself requires authentication, such as providing a valid KBA for that system or a biometric indicator, and uses the successful completion of that act as an authentication factor to complete the login process. In one embodiment, the authentication system may prompt the user to arm or disarm the premises security system (which may require entering in a PIN code, providing an audio code or other pass-phrase, using a designated gesture, providing a biometric input such as a face or retinal scan or a fingerprint, or the like). In one embodiment, the authentication system may itself provide a particular code, pass-phrase to speak, etc. to the user to use with the premises security system to demonstrate their proximity or access to that system. For example, the authentication system may instruct the user to enter in a specific PIN code into a keypad for the security system located at the premises.

If the premises security system confirms to the authentication system that the user successfully performed the desired action (e.g., entered the PIN used to arm/disarm the system, or spoke a code phrase provided by the authentication system), the authentication system may complete the login process (e.g., provide access tokens to the user application or enable access to the web portal). One non-limiting advantage of using a premises security system is it can be more secure than other methods for MFA, since it uses an established (and known) location for the user rather than a mobile device that could be more easily lost, stolen, or otherwise compromised. A premises security system can be used to confirm a location of a user who is attempting to login to the app or web portal. Moreover, it may be easier for a user to perform a task she is familiar with (e.g., arm/disarming a home security system) rather than other methods of MFA. Also, using a premises security system may have fewer steps than typical MFA techniques and/or be less burdensome than a process that requires the user to remember a combination of multiple KBAs.

In one embodiment, the embodiments herein may be used to log in a user to an application that enables the user to access or control the premises security system itself. For instance, the application can enable the user to view cameras that are part of the security system, or remotely arm or disarm the security system from the user device, change configuration settings, establish geo-fences, etc. Once authenticated, the user may remain logged in as the app is opened and closed on the user device. However, the embodiments herein can also be used to log the user into any application or web portal that could benefit from using the security system's known location to provide additional login security, such as a banking application, a government application, healthcare application, and the like.

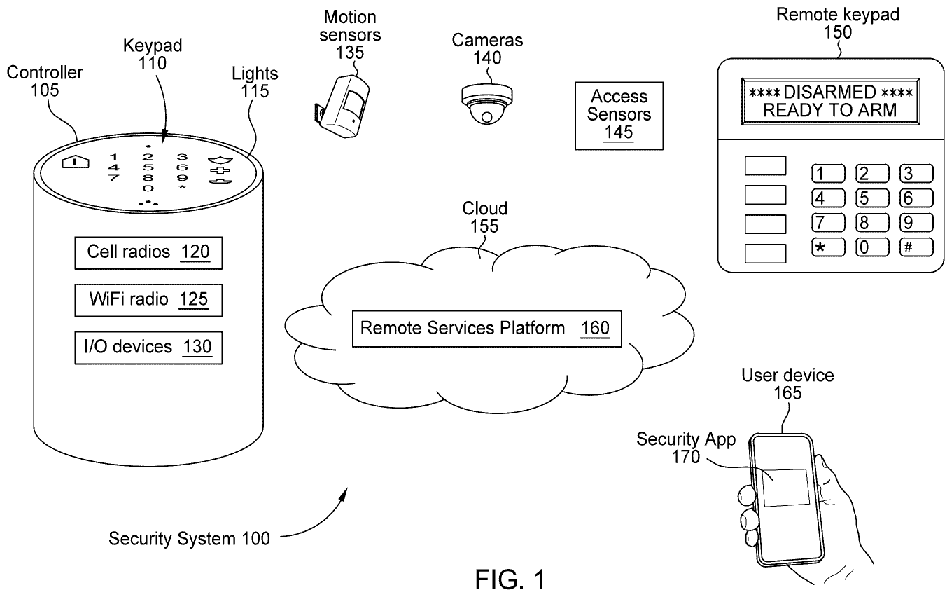

FIG. 1 illustrates a premises security system 100, according to one embodiment. The premises security system 100 includes a security system controller 105 (or security hub), motion sensors 135, cameras 140, access sensors 145, and a keypad 150. FIG. 1 also illustrates a cloud computing environment 155 and a user device 165 which can be used to remotely control the various devices in the premises security system 100.

The controller 105 includes a keypad 110, lights 115, cell radios 120, a Wi-Fi radio 125, and input/output (I/O) devices 130. In this example, the controller 105 is a device (e.g., a tower or box) that can communicate with the other devices in the security system 100 such as the motion sensors 135, cameras 140, access sensors 145, and the keypad 150. As shown, the controller 105 communicates wirelessly with these devices but in other implementations could have wired connections to the devices.

In one embodiment, the controller 105 serves as a relay between the devices in premises security system 100 and a remote services platform 160 in the cloud 155. For example, the controller 105 may use its Wi-Fi radio 125 (or another type of radio such as Bluetooth low energy (BLE)) to communicate with the motion sensors 135, cameras 140, and access sensors 145. Data collected from these devices can then be relayed to the remote services platform 160 using a local Wi-Fi network or a cellular network using one of the cell radios 120. However, in another embodiment, these devices can communicate with the remote services platform 160 without using the controller 105. For instance, the cameras 140 may have their own Wi-Fi connection to the platform 160 via the local Wi-Fi network. In one embodiment, the devices in the security system 100 can be Internet of Things (IoT) devices.

The controller 105 includes a keypad 110 which the user can use to enter a PIN to arm or disarm premises security system 100. The lights 115 can be used to provide feedback or instructions to the user. For example, when a user enters a home and triggers one of the sensors 145, the hub 105 can flash orange indicating the user should provide a PIN within a set time period. If the PIN is entered correctly, the lights 115 can turn green. If the PIN is entered incorrectly, the lights 115 can turn red.

In addition to the lights 115, the hub 105 can include other I/O devices 130 such as a speaker, a microphone, additional lights, a camera, fingerprint scanner, etc. The I/O devices 130 can be used to provide commands as well as sense user input, such as a code phrase, perform a face scan, scan a fingerprint, or capturing images of the environment.

Although not shown, the controller 105 can include any number of processors (e.g., central processing units or application specific integrated circuits) and memory for performing the functions described herein. For instance, the processor and memory can include software applications for communicating with the devices in the security system 100, communicating with the remote services platform 160, authenticating a user, performing voice recognition, performing facial scans, and the like.

The hub 105 can use the cell radios 120 as backup if the local Wi-Fi network is unavailable. For example, when power is lost, the Wi-Fi network may turn off. However, the hub 105 (which can include its own backup battery) can use the cell radios 120 to maintain communication with the remote services platform 160, such as receiving commands or informing the platform 160 if there is an intruder. Because power loss or natural disasters can also affect cell networks, the hub 105 can include multiple cell radios 120 for different cell networks. This redundancy can ensure the hub 105 can continue to communicate with emergency services via platform 160.

The motion sensors 135, cameras 140, and the access sensors 145 can be placed to monitor or guard entry points at the location (e.g., a home or business) to detect (or prevent) entry of an unauthorized person. For example, the access sensors 145 can be placed on windows and doors to alert the controller 105 when a window or door is opened when the security system 100 is armed. Or the access sensors 145 can detect glass breaking or other sounds of an intrusion.

One or more remote keypads 150 can be disposed around the premises, where keypad 150 may include physical keys or a touchscreen. For example, while the controller 105 may be located at a main entrance (in which case a user could use the keypad 110 on the controller 105 to arm/disarm the system 100), the remote keypad 150 may be located at a back or side door. As such, the remote keypad 150 may be optional and the user can rely solely on the controller 105 to arm and disarm the system 100. In another example, the controller 105 may not have the keypad 110 in which case one or more remote keypads 150 can be used to arm and disarm the system 100. For example, the user may type a PIN on the remote keypad 150 which then relays the PIN to the controller 105. The controller 105 can determine if the PIN is correct and disarm the various devices in the security system 100. In another embodiment, the hub 105 may forward the PIN to the remote service platform 160 which verifies the PIN and instructs the hub 105 to disarm the system 100.

As mentioned above, the remote services platform 160 serves as a portal to enable a user to remotely monitor and control the security system 100. In this example, the user device 165 (e.g., a smartphone, tablet, laptop, etc.) executes a security app 170 that enables the user to interact with the security system 100. For example, if the user forgot to disarm the security system 100 when leaving for work, she can use the security app 170 to instruct the platform 160 to arm the system. Or if someone wants to enter the premises when the user is not there, the user can disarm the security system without having to provide the PIN to the person. Moreover, the remote services platform 160 may enable the user to stream the feeds of the cameras 140 to the user device 165. Also, the user may be able to perform administrative tasks using the security app 170 such as registering new devices, changing the PIN or technique used to arm/disarm the system 100, paying subscriptions, and the like.

In one embodiment, the security app 170 is provided by the same company or vendor that provides the physical devices in the security system 100 (i.e., the controller 105 and various other sensors). However, the security app 170 could be a third-party app, such as an app that works across vendors.

The cloud 155 can include compute resources in one or more data centers. The platform 160 can be implemented in the cloud 155 in one data center, or multiple data centers in various geographical locations. The platform 160 can store the configuration information for the user and the security system 100. For example, the platform 160 can register the various devices in the security system 100 and monitor the outputs generated by these devices (when provided by the hub 105). The controller 105 may detect when a new device (e.g., a new sensor) has been added to the system 100 and inform the platform 160. In turn, the platform 160 can push an alert to the security app 170 and walk the user through a process to register the new device.

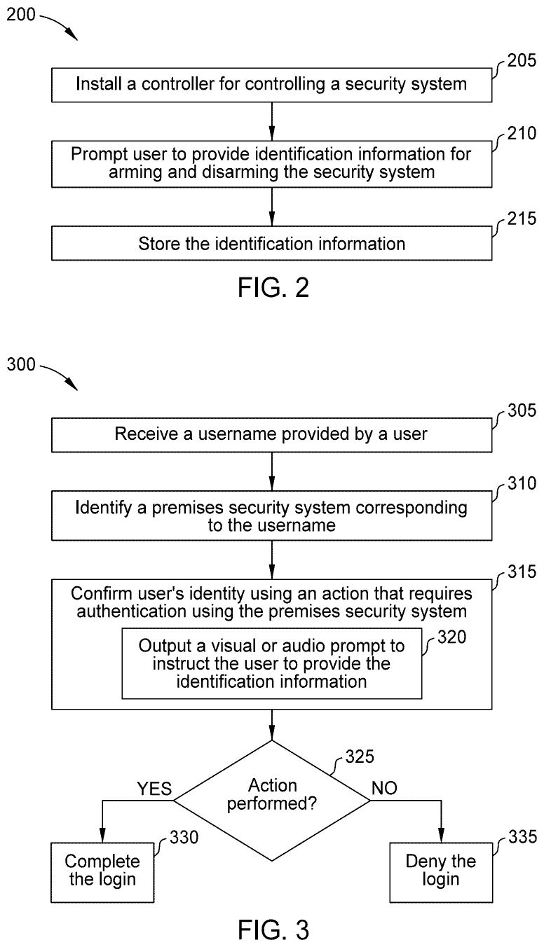

FIG. 2 is a flowchart of a method 200 for establishing identification information for arming and disarming a security system, according to one embodiment. The method 200 assumes that a user is setting up a new alarm system at a desired location, e.g., a home or business.

At block 205, the user installs the controller (e.g., the controller 105 in FIG. 1) for controlling the security system. The controller can communicate with other devices (e.g., cameras and sensors discussed above) and relay that information to a platform (e.g., the remote services platform 160 in FIG. 1). The platform can help the user to install and configure the controller and other devices in the security system using a security app installed on a user device (e.g., security app 170 in FIG. 1).

At block 210, the controller (or the platform) prompts the user to provide identification information for arming and disarming the security system. For example, the hub can instruct the user to enter in a 4 or 6 digit PIN using a built-in keypad (e.g., the keypad 110) in the controller or a remote keypad (e.g., the keypad 150). In another embodiment, the identification information may be a voiceprint, a code phrase, gesture or a facial scan (e.g., using cameras 140) or the like. In yet another embodiment, the identification information is a fingerprint which is read using a fingerprint scanner on the controller or a remote pad (such as part of keypad 150 or as part of a smart lock or other device). The embodiments herein can use any suitable identification information that permits the security system to determine that someone who has entered (or wants to enter) the location and take an action has permission to do so, and in response, for example, disarm the security system.

At block 215, the controller stores the identification information provided by the user. That way, at a later time the user can use the identification information to disarm the system. Moreover, in some embodiments the identification is used to both arm and disarm the system but this is not a requirement. For example, the security system may permit any person at the location to arm the system (e.g., by pressing a button on the hub or the remote keypad), but requires the identification information in order to disarm the system.

In one embodiment, the identification information may also be stored in the platform. For example, if the user forgets the PIN used to disarm the system, the platform can provide a process by which the user can retrieve the PIN (or set a new PIN). Moreover, the platform may be tasked with arming or disarming the security system, remotely, and thus, may store the identification information.

FIG. 3 is a flowchart of a method 300 for using a technique for arming or disarming a security system to provide a secure login, according to one embodiment. The method 300 assumes that the method 200 has already been performed where a security system has been installed and the user has established identification information that can be used to disarm the system.

At block 305, an authentication system receives a username provided by a user during a login request. The login request may be to sign into an application (e.g., the security app 170 in FIG. 1, a banking app, a government app, etc.) or a web portal. In the method 300, the user is assumed to be someone who knows the identification information to disarm the security system. For example, the user may have the PIN or code phrase for disarming the security system. Or a voiceprint, facial scan, or fingerprint of the user can be used to disarm the security system.

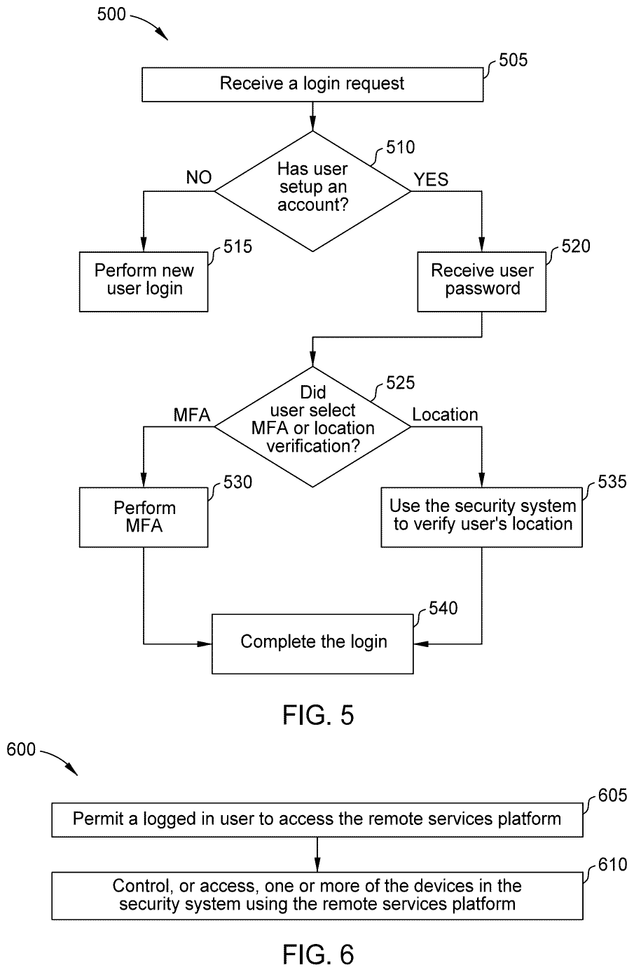

Moreover, the authentication system may have already received a username and password from the user as they attempt to login, but is leveraging the premises security system to provide an additional level of security to ensure a nefarious actor has not gotten access to the username and password. The premises security system can ensure that someone who is currently logging into the application is at the same location as the security system and can provide the identification information (or can at least instruct someone who is at the location to provide the identification information). Additional details regarding receiving the user's username and password is described in FIG. 5 below.

At block 310, the authentication system (or the remote services platform) identifies a premises security system associated with the username provided by the user. For example, the authentication system can use the username to query the remote services platform and determine that the user has already installed a security system, or is an authorized user of a security system.

At block 315, the security system confirms the user's identity using an action that requires authentication using the premises security system. In one embodiment, the action may be the same technique used to disarm the security system (e.g., the disarming technique). For example, the security system may prompt the user to provide the PIN, code phrase, voiceprint, fingerprint or any of the other identification information that was discussed in method 200 to disarm (or arm) the security system. In one embodiment, the user is prompted to provide the identification information to the controller, but in other embodiments, the information can be provided to other devices in the security system such as a remote keypad or other sensor. As such, the method 300 is not limited to a security system that includes a controller but can be used with any security system that receives user input to arm or disarm the system. For example, a keypad may be an IoT device that can directly communicate with the platform without using a controller. Or the user may have a fob that she can place on a reader at the location to disarm the system. Thus, regardless whether the security system has a controller, a user action can be used by the authentication system to determine that the user is at a secure location.

By knowing the user is at the location, this can verify that the user who is attempting to login into the application or web portal is an authorized user rather than a nefarious actor. While typical MFA techniques attempt to verify a user's identity using a secondary form of communication (e.g., text messages, email, voice call) to confirm the user has access to a known user device, in method 300 the authentication system uses the security system to confirm the user currently logging in has access to (or is at) the same location as the security system. This MFA variant provides additional assurance that the user attempting to log in with a username/password combination is the true owner of the account.

However, in other embodiments, the method 300 can be used in place of asking the user for a password. Since passwords can be difficult to memorize, the authentication system may offer to the user the option of instead using the security system to provide access.

As part of block 315, at sub-block 320, an I/O device in the security system outputs a visual or audio prompt to instruct the user to provide the identification information. If the security system includes a controller, the platform can instruct the controller to use a speaker to output an audible prompt to the user to provide the identification information, or lights on the controller can flash in a similar way to indicate that the user should enter her PIN in order to disarm the security system. If the security system does not include the controller, an IoT device such as a remote speaker or a display on a keypad can be used to provide an audio prompt or display instructions to the user.

In another embodiment, rather than using the security system to prompt the user to provide the identification information, the authentication system could use the app or web portal the user is attempting to log into to provide instructions. For example, the app or web portal can display instructions such as “provide the PIN you use to disarm your arm system on the controller in order to complete the login in process.” Of course, this message can vary depending on the type of identification information used by the security system.

At block 325, the authentication system determines whether the user performed the action. In this manner, the security system can confirm the identity of the user attempting to login. For example, the remote services platform can inform the authentication system when the correct identification information was provided by the user.

Moreover, the controller may ensure it is at the intended location before confirming the action was performed, and thus, confirming the user's identity. For example, the controller may use its cell radios to perform triangulation (or use GPS if available) to ensure it has not been moved or stolen. This prevents a nefarious actor from taking the controller and using it to complete the login process when the actor is not at the location that is being guarded by the security system.

If the user provided the correct information using the security system, the method 300 proceeds to block 330 where the authentication system completes the login which gives the user access to the app or web portal.

However, if the user did not provide the correct information and the authentication system was unable to confirm the user's identity, the method 300 proceeds to block 335 where the authentication system denies the login attempt.

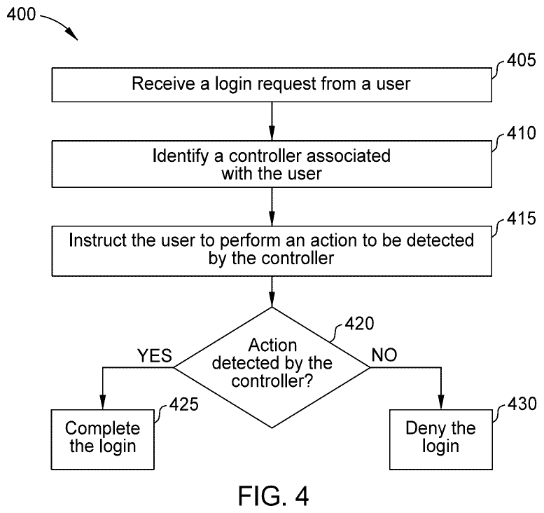

FIG. 4 is a flowchart of a method 400 for using a controller of a security system to provide a secure login, according to one embodiment. Like method 300, the method 400 assumes that the method 200 has already been performed where a security system has been installed and the user has establish identification information that can be used to disarm the system. However, unlike in method 300 where the user uses the same identification information that arms or disarms the security system to complete the login, in method 400 the security system can verify the user's location using the security system but using other security credentials besides the ones used to arm/disarm the security system.

At block 405, an authentication system receives a login request from a user. The login request may be to sign into an application (e.g., the security app 170 in FIG. 1, a banking app, a government app, etc.) or a web portal. In method 400, the user is assumed to be someone who has permission to enter the premises that includes the alarm system. For example, the user may have access to the building that contains the controller of the security system.

Like in method 300, here, the authentication system may have already received a username and password from the user, but is leveraging the security system to provide an additional level of security to ensure a nefarious actor has not gotten access to the username and password. The security system can ensure that someone who is currently logging into the application is at the same location as the security system so that the user can provide a security credential when prompted. This user can be a user who is authorized to provide the identification information to disarm or arm the system, but it does not have to be. For example, the user could be someone who is staying at the residence, or an employee who is authorized to login to the app or web portal but does not have the identification information for arming/disarming the security system. Such a person can still use the security system to log into the app or web portal without having to have the information for arming/disarming the security system.

At block 410, the authentication system (or the remote services platform) identifies a controller associated with the user. For example, the authentication system can use the username to query the remote services platform and determine that the user has already installed a security system, or is an authorized user of a security system. For example, the user may be listed as someone is authorized to access the location that includes the security system such as friends and family, employees, and the like.

In one embodiment, the remote services platform can maintain a list of people (and usernames) that are authorized to access a location monitored by the security system. As such, when provided a username by the authentication system, the platform can confirm that user has access to the location and use the security system to confirm the person's identity using the controller.

At block 415, the controller instructs the user to perform an action which can be detected at the controller. As mentioned above, this action can be different from the identification information for arming or disarming the security system. For example, the platform can instruct the controller to use a speaker to output an audible prompt to the user to enter in a PIN that was provided by the authentication system to the user. Or the authentication system may instruct the user to press a specific button on the controller, or say a specific code phrase that is detected by the controller. Again, the PIN, button, code phrase, etc. may be different actions or security credentials then used to arm or disarm the security system.

While method 400 specifically describes using the controller, other devices (e.g., IoT devices) in the security system could be used to determine whether the user performed a specific action. For example, a remote speaker or an IoT keypad can be used to detect whether the user has performed an action. In any case, the method 400 can be used to allow people who may not have the identification information to arm or disarm the security system to still use the security system to enable a secure login process.

At block 420, the authentication system determines whether the action was detected by the controller. For example, the controller can inform the remote services platform what action was performed (e.g., the PIN that was entered, the code phrase the user said, etc.) which the platform can relay to the authentication system. In turn, the authentication system can determine whether the action detected by the controller was the one the authentication system told the user to perform using the app or the web portal.

If the controller detected the correct action, the method 400 proceeds to block 425 where the authentication system completes the login which gives the user access to the app or web portal.

However, if the user did not perform the correct action and the authentication system was unable to confirm the user's location, the method 400 proceeds to block 430 where the authentication system denies the login attempt.

Thus, the method 400 describes that other actions, besides the action used to disarm or arm the security system, can be used to provide a secure login to an app or web portal.

FIG. 5 is a flowchart of a method 500 for using a security system or MFA to provide a secure login, according to one embodiment. The method 500 describes an example login system where the security system can be leveraged to securely log in a user, as discussed in FIGS. 3 and 4 above. However, FIGS. 3 and 4 are not limited to the embodiments describe in method 500.

At block 505, an application or web portal receives a login request from user.

At block 510, the application or web portal determines whether the user has already set up an account. For example, the user may enter in an unknown username, in which case, the method 500 proceeds to block 515 where the application performs a process associated with a new user login. For example, the app or portal may help the user create a new account.

However, assuming the username and account are known, the method 500 proceeds to block 520 where the user provides a password.

An already registered user may have to login again (or re-authenticate) to an app or at a web portal for any number of reasons. For example, the user may be logging in from a new (or unrecognized) device. For instance, the user may have purchased a new mobile phone or laptop and is logging in from that device for the first time. Or an access token used by the app may have expired. Or the app or web portal may have detected suspicious activity and logged out the user so she has to repeat the authentication process.

When providing the password, the app or web portal may also prompt the user whether they want to confirm their identity using typical MFA techniques (e.g., determining whether a known user device is within the procession of the user) or perform MFA using a security system (e.g., determining whether the user is at a same location as the security system). Thus, in this example, the app or portal can give the option to the user which to use.

However, in other examples, the app or portal may not give the option to the user. For example, the app may have location information regarding the user and detect she is at a location of the security system, and thus, require her to use the security system to log in. However, if the location information indicates she is not at the location of the security system, typical MFA techniques may be used.

At block 525, if the user selected (or the app or portal selected) to use typical MFA techniques, the method 500 proceeds to block 530 where one of those techniques is used to confirm the user's identity. However, if the user instead selected using the security system, the method 500 proceeds to block 535 where the security system verifies the user's location, and hence, the user's identity. At block 535, any of the embodiments described above in FIGS. 3 and 4 can be used to verify the user's location and identity.

At block 530, the authentication system completes the login, assuming the processes at block 530 or block 535 was successful.

FIG. 6 is a flowchart of a method 600 for using an application to control and access a security system, according to one embodiment. In one embodiment, the method 600 is performed after a user successfully logs into an app (or a web portal) using any of the embodiments discussed above in FIGS. 3-5.

After a user successfully logs in, at block 605, the authentication system permits a logged in user to access the remote service platform. The authentication system can provide an access token to access the remote service platform, or enable the use of application programming interfaces (APIs) to access the remote service platform.

At block 610, the user controls, or accesses, one or more of the devices in the security system using the remote services platform. In one embodiment, the remote services platform serves as a portal to enable the user to remotely monitor and control the security system using the app or portal. For example, if the user forgot to disarm the security system when leaving for work, she can use the app (e.g., the security app 170 in FIG. 1) to instruct the platform to arm the system. Or if someone wants to enter the premises when the user is not there, the user can disarm the security system without having to provide the PIN to the person. Moreover, the remote services platform may enable the user to stream the feeds of cameras in the security system to the user device. Moreover, the user may be able to perform administrative tasks using the app such as registering new devices, changing the PIN or technique used to arm/disarm the system, and the like.

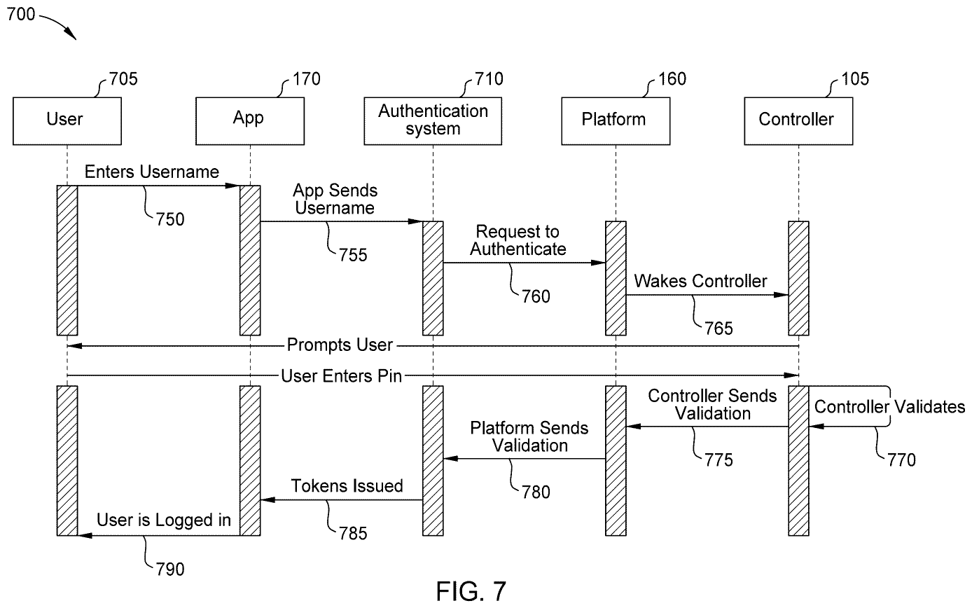

FIG. 7 is a workflow 700 for logging a user into an application using a security system controller, according to one embodiment. The workflow 700 illustrates using a controller 105 to enable secure access to the security app 170. However, the workflow 700 could also be used to provide secure access to a web portal. Moreover, other devices in a security system besides the controller 105 could be used to confirm the user's identity, such as any suitable IoT device.

At 750, the user 705 enters a username into the security app 170 to begin the login process. For example, an already registered user may have to login again (or re-authenticate) to the app because the user may be logging in from a new (or unrecognized) device, or because an access token used by the app may have expired. Or the app may have detected suspicious activity and logged out the user so she has to repeat the authentication process.

At 755, the app 170 relays the username to the authentication system 710. In one embodiment, the authentication system 710 manages tokens that permit the security app 170 to access the remote service platform 160. Thus, after logging in, the user 705 can use the app 170 to access and control the security system as described in the method 600 in FIG. 6.

At 760, the authentication system 710 transmits a request to authenticate the user to the remote services platform 160. This request can include the username provided by the user 705. That way, the platform 160 can identify a security system corresponding to the user 705. Although not shown, if there is not a security system associated with the username, the platform 160 may return an error to the app 170 in which case it can query the user 705 to ensure the username was entered correctly, or to begin the process of creating a new account.

At 765, the platform 160 wakes the controller 105 in the security system corresponding to the username. In one embodiment, the hub 105 (or the app 170) can provide an audio or visual prompt to the user to provide the same identification information that the user uses to arm or disarm the security system. This was described in FIG. 3. In another example, the app 170 provides security credentials to the user 705 (e.g., a new PIN or a code phrase) and instructs the user to enter those credentials into the controller. These credentials can be different from the identification information used to disarm the security system, which was discussed in FIG. 4.

At 770, the controller validates the request by detecting whether the user correctly entered in the identification information, or provided the correct security credentials.

At 775, the controller informs the platform 160 that the correct action was performed by the user 705. However, in other embodiments, the controller may send the action to the platform 160 and the platform 160 (or the authentication system 710) determines whether the correct action was performed.

At 780, the platform 160 sends a validation to the authentication system 710.

At 785, the authentication system 710 issues an access token to the app 170. In one embodiment, the access token permits the app 170 to gain access to the platform 160.

At 790, the app 170 logs in the user 705, and because the app 170 has the access token, it can now access the platform 160 and can monitor and control the security system, which includes the controller 105.

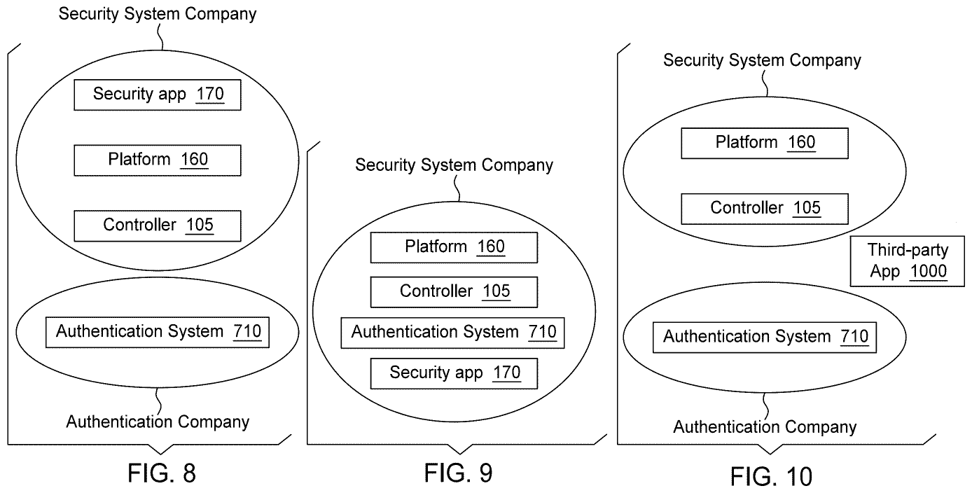

FIG. 8 illustrates one example implementation of the workflow in FIG. 7. In this example, the security app 170, platform 160, and controller 105 are sold, developed, and/or managed by a security system company. For example, the security system company may offer the security app 170 and the platform 160 as way for a customer (who purchased the controller 105) to access and control the controller 105 using a device that has installed the security app 170. This was discussed in FIG. 6.

In this example, an authentication company can provide and maintain the authentication system 710. For example, the security system company may contract or partner with the authentication system 710 to verify login in attempts to the security app. As shown in FIG. 7, the security app 170 and the platform 160 can communicate with the authentication system 710 in order to use the security system (e.g., the controller 105) to verify a user's location.

FIG. 9 illustrates one example implementation of the workflow in FIG. 7. Here, the platform 160, the controller 105, the security app 170, and the authentication system 710 are sold, developed, and/or managed by a security system company. In this example, the security system can control the entire login process (except for the user device).

FIG. 10 illustrates one example implementation of the workflow in FIG. 7. Like in FIG. 8, the platform 160 and the controller 105 are provided by the security system company while the authentication system 710 is provided by a separate authentication company. However, the app 1000 may be a third part app that is not provided by either the security system company or the authentication company. For example, the app 1000 may be a third-party app made by a different security company that interfaces with the platform 160 to control the user's security system. The security system company may contract or partner with other security company to provide the app 1000.

In yet another embodiment, the third-party app 1000 may be not be an app for controlling or access a security system, and instead could be a banking app, a government app, a business's custom app used by its employees, and the like. This third-party company can nonetheless leverage the location verification processes discussed above to provide an additional level of security to verify login attempts to the app 1000.

While the authentication system 710 is shown as being provided by the authentication company, in another embodiment of FIG. 10, the authentication system 710 could be provided by the security system company.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving a username provided by a user that is part of a login request;
identifying a premises security system corresponding to the username provided by the user, wherein the premises security system comprises at least one physical device configured for the detection of an intrusion at a premises by an unauthorized person and is configured for an action that requires authentication using the premises security system;
determining, using the physical device, that the action was performed on the security system; and
responsive to determining that the action was performed, transmitting a confirmation to an authentication system so the login request can be approved.

2. The method of claim 1, wherein the action comprises at least one of arming the premises security system, disarming the premises security system, providing a code using the premises security system, providing a pass-phrase using the premises security system, providing a gesture using the premises security system, providing a biometric indicator using the premises security system.

3. The method of claim 1, wherein the username is provided to log the user into an application or a web portal, wherein the user is a registered user of that application or web portal.

4. The method of claim 3, wherein, once logged in, the application or the web portal permits the user to remotely control or access the physical device for the premises security system.

5. The method of claim 1, wherein the physical device comprises at least one controller.

6. The method of claim 5, wherein the physical device comprises a keypad, wherein the user enters in a PIN using the keypad to arm or disarm the premises security system.

7. The method of claim 5, wherein the premises security system comprises at least one sensor configured to monitor an entry to the location, wherein the security controller is configured to wirelessly receive output data from the sensor.

8. An apparatus, comprising:
an input/output (I/O) device for disarming or controlling a premises security system, wherein the I/O device is further configured to detect a user action that is performed as part of a request to log into an application or a web portal; and
a radio configured to transmit, upon detecting the user action, a confirmation of an identity of a user so the login request can be approved.

9. The apparatus of claim 8, wherein the login request is to an application or a web portal, wherein the user is a registered user of the application or web portal.

10. The apparatus of claim 8, wherein, once logged in, the application or the web portal permits the user to remotely control or access the apparatus.

11. The apparatus of claim 8, wherein the radio is a cell or Wi-Fi radio.

12. The apparatus of claim 11, further comprising:
a keypad, wherein the user action is entering a PIN onto the keypad.

13. The apparatus of claim 12, wherein the PIN is a same PIN used to arm or disarm the premises security system.

14. The apparatus of claim 12, wherein the PIN is provided to the user by the application or the web portal, wherein the PIN is different from a PIN used to arm or disarm the premises security system.

15. The apparatus of claim 8, wherein the apparatus is a controller that wirelessly receives output data generated by one or more sensors in the premises security system.

16. A non-transitory computer readable medium containing computer program code that, when executed by operation of one or more computer processors, performs an operation comprising:
receiving a username provided by a user that is part of a login request;
identifying a premises security system corresponding to the username provided by the user, wherein the premises security system comprises at least one physical device configured for the detection of an intrusion at a premises by an unauthorized person and is configured for an action that requires authentication using the premises security system;
determining, using the physical device, that the action was performed on the premises security system; and
responsive to determining that the action was performed, transmitting a confirmation to an authentication system so the login request can be approved.

17. The non-transitory computer readable medium of claim 16, wherein the action comprises at least one of arming the premises security system, disarming the premises security system, providing a code using the premises security system, providing a pass-phrase using the premises security system, providing a gesture using the premises security system, providing a biometric indicator using the premises security system.

18. The non-transitory computer readable medium of claim 16, wherein the username is provided to log the user into an application or a web portal, wherein the user is a registered user of that application or web portal.

19. The non-transitory computer readable medium of claim 16, wherein, once logged in, the application or the web portal permits the user to remotely control or access the physical device for the premises security system.

20. The non-transitory computer readable medium of claim 16, wherein the physical device comprises at least one controller, wherein the physical device comprises a keypad, wherein the user enters in a PIN using the keypad to arm or disarm the premises security system.
